(19) United States
(12) Patent Application Publication
(10) Pub. No.: US 2013/0343877 A1
(43) Pub. Date: Dec. 26, 2013

(54) REGULATABLE COOLANT PUMP

(71) Applicants: Michael Weiss, Herzogenaurach (DE); Klaus Hahn, Oberreichenbach (DE)

(72) Inventors: Michael Weiss, Herzogenaurach (DE); Klaus Hahn, Oberreichenbach (DE)

(73) Assignee: Schaeffler Technologies AG & Co. KG, Herzogenaurach (DE)

(21) Appl. No.: 14/004,260

(22) PCT Filed: Jan. 31, 2012
(86) PCT No.: PCT/EP2012/051547

§ 371 Date: Sep. 10, 2013

(30) Foreign Application Priority Data
Mar. 14, 2011 (DE) 102011005473.1

(51) Int. Cl. F02B 39/12

(52) U.S. Cl. CPC F02B 39/12
USPC 415/123

(57) ABSTRACT

The invention relates to a regulatable coolant pump for a cooling circuit of an internal combustion engine, comprising a hollow bearing shaft (1) carrying a drive wheel (2) on one end thereof and being secured to an impeller (18) on the opposite end thereof. The impeller (18) includes an abutment surface (19) on the front side, and the space between the impeller (18) and the abutment surface (19) is embodied as a conveying cross-section (22). The drive wheel (2) can be uncoupled from the bearing shaft (1) via a draw key (3).

The present invention relates to a regulatable coolant pump for a cooling circuit of an internal combustion engine, including a hollow bearing shaft carrying a drive wheel on its one end and is fixedly connected to an impeller on its opposite end, the impeller having an abutment surface on its front side, and the space between the impeller and the abutment surface being designed as a conveying cross section.

In the field of internal combustion engines, water-cooled engines have become widely accepted. With the aid of a coolant pump in a closed circuit, cooling water is pumped through cooling channels in the area of the cylinders for cooling the internal combustion engine and subsequently conveyed to an air/water cooler, where the heated water is cooled again with the aid of the air stream. The pump needed for circulating the water is usually connected to a belt pulley of the crankshaft of the internal combustion engine via a belt.

The direct coupling between the coolant pump and the crankshaft ensures that the rotational speed of the pump is dependent on the rotational speed of the internal combustion engine. As a result, a corresponding volumetric flow through the pump is provided within the high rotational speed range of the internal combustion engine, which is not needed to this extent for cooling. During a cold start of the internal combustion engine, however, the problem arises that coolant is already circulating through the cooling channels, which hinders the heating of the combustion chambers and thus delays the reaching of an optimal operating temperature.

### BACKGROUND

A regulatable coolant pump according to the aforementioned definition of the species is known from the publication DE 10 2008 046 424. In this publication, a guide disk having a contour corresponding to the impeller is situated between the impeller and a cover disk, the guide disk being guided by axial webs, connecting the impeller and the cover disk, and being axially movable via a controlling unit with the aid of a piston placed within the hollow shaft.

The guide disk has a projection on its outer edge which is oriented in the direction of the impeller and with the aid of which the guide disk covers the annular channel of the pump housing depending on its position between the impeller and the cover disk. This has the advantage that the annular channel may be covered with the aid of simple means. The controlling unit is designed in the manner of an armature which is fixedly connected to the piston and which is axially movable in a targeted manner via a proportional solenoid. Intermediate positions of the guide disk may also be implemented with the aid of a configuration of this type.

In the water pump illustrated in the prior art, the proportional solenoid would have to apply a force of approximately 200 N. This would result in the solenoid having to be given disproportionately large dimensions in relation to the actual water pump. However, the crucial disadvantage is that the impeller also always rotates when the drive wheel is being driven, since the impeller is connected directly to the crankshaft, even when cooling of the engine is not yet desired.

### SUMMARY OF THE INVENTION

It is an object of the present invention to provide a cost-effective, installation space-optimized, regulatable water pump.

The present invention provides that the drive wheel may be uncoupled from the bearing shaft with the aid of a draw key. Due to the uncoupling, the drive wheel continues to be driven by the rotating crankshaft gear, while the bearing shaft is uncoupled and stands still, as does the impeller. This procedure is required both to reduce unnecessary power output and to warm up the internal combustion engine more rapidly during a cold start, since the pump does not yet pump water through the system.

In further specifying the present invention, it is proposed that the bearing shaft has a hollow design and the draw key is linearly movably situated therein. This space-saving design is particularly advantageous, since it permits a dual use of the installation space used by the bearing shaft.

According to another preferred refinement of the present invention, it is proposed that the draw key is linearly adjustable with the aid of an actuator. The actuator may be operated mechanically, hydraulically, pneumatically, electrically, magnetically or in another way.

According to another preferred refinement of the present invention, a one-sidedly open cylinder on the impeller side is linearly movably situated in the hollow bearing shaft, and one side of the draw key, in turn, is linearly guided in the cylinder. To adapt the quantity of the water throughput within the pump to the cooling requirements of the engine, a guide disk is mounted on the front side of the cylinder base of the one-sidedly open cylinder. The guide disk has a projection on its outer edge which is oriented in the direction of the impeller and with the aid of which the guide disk partially or completely closes the conveying cross section, depending on the axial position of the cylinder.

Moreover, pressure is axially applied to the draw key by a first spring and a second spring. This safety measure ensures that the drive wheel is nonrotationally connected to the bearing shaft if the actuator fails, and the conveying cross section is reopened by pushing the draw key, to which the spring pressure is applied, into the necessary position.

In one preferred embodiment of the present invention, it is provided to situate a coupling in the bearing point of the pivot of the drive wheel, the draw key, the bearing shaft, the drive wheel and coupling bodies situated between the draw key and the drive wheel forming the coupling. Placing the coupling in the pivot of the drive wheel is another way to save installation space. Due to the force-fitted connection between the drive wheel and the bearing shaft, the direct transmission of force or torque from the crankshaft gear to the bearing shaft is ensured.

According to another preferred embodiment of the present invention, it is provided that the bearing point of the pivot of the drive wheel has a shifting geometry, the shifting geometry having radially and axially running grooves with which the coupling bodies engage. In the coupled state, the coupling bodies are clamped in an indentation of one of the axial grooves. The axial grooves, which are spaced a distance apart, are embedded deeper into the bearing point than the radial grooves, which are situated between the axial grooves. The drive wheel is advantageously manufactured in an injection molding or sintering process in such a way that the shifting geometry formed in the pivot of the drive wheel may be easily produced.

It has proven to be advantageous to design the coupling bodies as rolling elements. In other words, the coupling bodies may be given a spherical, cylindrical or barrel-like shape.

One particular advantage of the present invention is that both the uncoupling of the drive wheel and the closing of the conveying cross section with the aid of a guide wheel take place by actuating a single component, namely a draw key. Due to this design, the regulatable water pump may be manufactured in a particularly space-saving manner.

### BRIEF DESCRIPTION OF THE DRAWINGS

The exemplary embodiment of the present invention is illustrated in FIGS. 1 through 3, which are described in detail below.

FIG. 1a shows a schematic representation of a regulatable water pump in the coupled state, having a maximum volumetric flow rate;

FIG. 1b shows a detailed representation of the shifting geometry at the bearing point of the drive wheel;

FIG. 2 shows a schematic representation of a regulatable water pump in the coupled state, having a zero volumetric flow rate; and

FIG. 3 shows a schematic representation of a regulatable water pump in the uncoupled state, having a zero volumetric flow rate.

### DETAILED DESCRIPTION

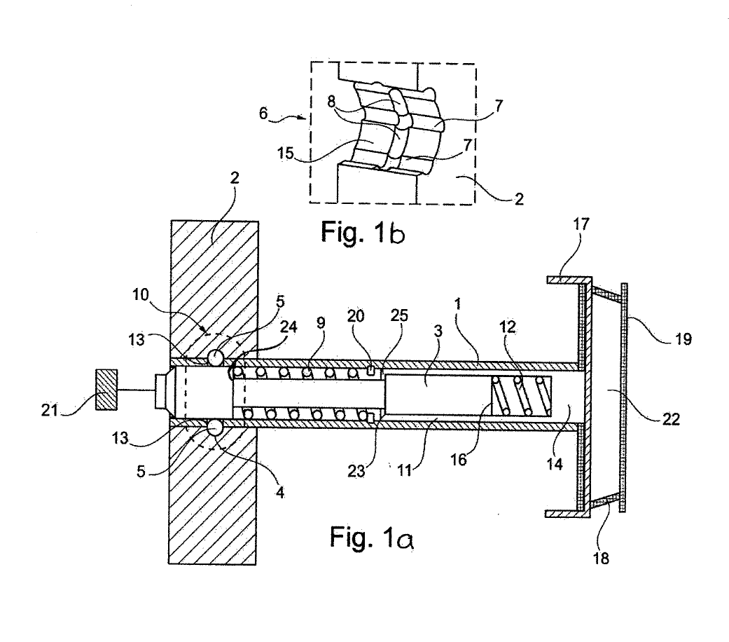

FIGS. 1 through 3 show a regulatable water pump, including a hollow bearing shaft 1 which has a drive wheel 2 on its one end and an impeller 18 on its opposite end. Impeller 18 has an abutment surface 19 on its front side, and the impeller is connected to the abutment surface to form a single piece. The space between impeller 18 and abutment surface 19 is designed as a conveying cross section 22 for the water to be conveyed. Conveying cross section 22 is located, so to speak, between a suction chamber and a pressure chamber.

A draw key 3 is linearly shifted within hollow bearing shaft 1 with the aid of an actuator 21. Draw key 3 has different diameters. Draw key end 16 which faces impeller 18 is enclosed by a one-sidedly open cylinder 11 which is also linearly movably situated in bearing shaft 1. To adapt the quantity of the water throughput within the pump to the cooling requirements, a guide disk 17 is mounted on the front side of cylinder base 14 of one-sidedly open cylinder 11. Guide disk 17 has a projection on its outer edge which is oriented in the direction of impeller 18 and with the aid of which guide disk 17 may partially or completely close conveying cross section 22, depending on the axial position of cylinder 11. The movement of one-sidedly open cylinder 11 is limited, on the one hand, by abutment surface 19 and, on the other hand, by an abutment 20 introduced into hollow bearing shaft 1, which may be designed as an annular disk. Cylinder 11 has a taper 25 on its open end. A first spring 12 is situated between draw key end 16 situated in cylinder 11 and cylinder base 14. First spring 12 is supported against cylinder base 14 by its one end and against draw key end 16 by its other end. Due to its different diameters, draw key 3 has a first radial shoulder 23 in the area enclosed by cylinder 11. The linear movement of draw key 3 within cylinder 11 is limited by the fact that it hits taper 25 of cylinder 11 with its first shoulder 23. Draw key 3 furthermore has a second spring 9, which encloses draw key 3 in an area having a smaller diameter. Second spring 9 is supported by its one end on aforementioned annular shoulder 23, which is situated in bearing shaft 1. Second spring 9 is supported by its other end on another second shoulder 24 of draw key 3.

In the initial position of the draw key (FIG. 1a), both springs 9, 12 are relaxed, draw key 3 is in its maximum extended position, and guide disk 17 completely releases conveying cross section 22.

A coupling 10 is situated between bearing shaft 1 and drive wheel 2. The function of the coupling is explained in greater detail below (FIG. 1b).

A linearly movable draw key 3 is situated in hollow bearing shaft 1; draw key 3 having different diameters. Bearing shaft 1 has multiple openings 13 on its circumferential side in the area of coupling 10, in which coupling bodies 5 are situated. Coupling bodies 5 are rotatably movably mounted in openings 13. In the radial bearing shaft direction, the mobility of coupling bodies 5 is limited on one side by an adjacent bearing point 4 of drive wheel 2 and on the opposite side by draw key 3. Draw key 3 is linearly moved within bearing shaft 1 with the aid of an actuator 21. The subarea of draw key 3 having the larger diameter is guided along the inner circumferential surface of bearing shaft 1. If the subarea having larger diameter D strikes coupling bodies 5 during the shifting of draw key 3, coupling bodies 5 are pushed out of their original position in the direction of bearing point 4 of drive wheel 2 and clamped in a form-fitted manner. A shifting geometry 6 is provided within bearing point 4 of drive wheel 2 (see FIG. 1b). Shifting geometry 6 is formed from axially running grooves 7 and from radially running grooves 8. Axial grooves 7 are spaced an equal distance apart and distributed on the circumference of bearing point 4, creating flat webs 15 between axial grooves 7 in bearing point 4. Radial grooves 8 are circumferentially introduced within these flat webs 15 in a type of circular trajectory. Axial grooves 7 are introduced deeper into bearing point 4 than radial grooves 8. When draw key 3 shifts coupling bodies 5 in the direction of bearing point 4 of drive wheel 2 or in the direction of shifting geometry 6, coupling bodies 5 engage with deeper situated axial grooves 7 in such a way that flat webs 15 adjoining axial grooves 7 prevent a radial deflection of coupling bodies 5. A rotatably fixed connection is thereby established between bearing shaft 1 and drive wheel 2. If drive wheel 2 is driven by a driving means, which is not illustrated herein, e.g., a camshaft gear or belt, bearing shaft 1 rotates as a result of the rotatably fixed connection.

For the reasons explained above, it may be advantageous in some operating states, e.g., during engine startup, if bearing shaft 1 does not concurrently rotate. However, since the crankshaft gear is constantly directly or indirectly engaged with drive wheel 2, the drive wheel is always also driven once the crankshaft gear begins to rotate. To enable the rotatably fixed connection between bearing shaft 1 and drive wheel 2 to be released, draw key 3 must be shifted. When draw key 3 is shifted, its subarea having larger diameter D is brought out of the contact area of coupling bodies 5, so that coupling bodies 5 are able to return to their original position. In their original position, coupling bodies 5 rest against both draw key 3 and bearing point 4. Since coupling bodies 5 no longer extend so far into bearing point 4, they slide into radially running grooves 8. In this uncoupled state, coupling bodies 5 only roll along radial grooves 8 acting as a track. Drive wheel 2 is thus idle. Another advantage of shifting geometry 6 designed according to the present invention is that drive wheel 2 is axially secured by radial grooves 8 which are embedded less deeply into bearing point 4 and with which coupling bodies 5 engage.

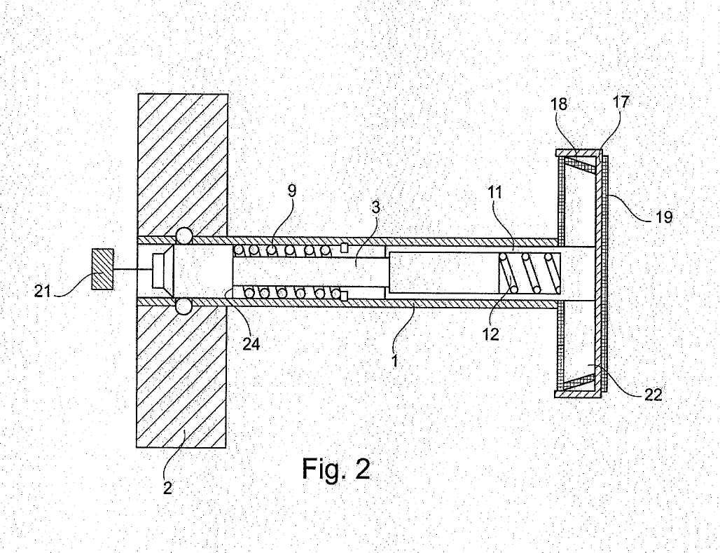

FIG. 2 shows how draw key 3 is moved in the direction of abutment surface 19 under the force influence of actuator 21. Second shoulder 24 of draw key 3 compresses second spring 9. To enable the driving force acting upon draw key 3 to be transmitted to one-sidedly open cylinder 11 and to guide disk 17 connected thereto, and to also move these components, it is necessary for first spring 12 to have a greater spring constant than second spring 9. Draw key 3 continues to be moved until guide disk 17 hits abutment surface 19, which completely closes conveying cross section 22, and a so-called zero volumetric flow prevails.

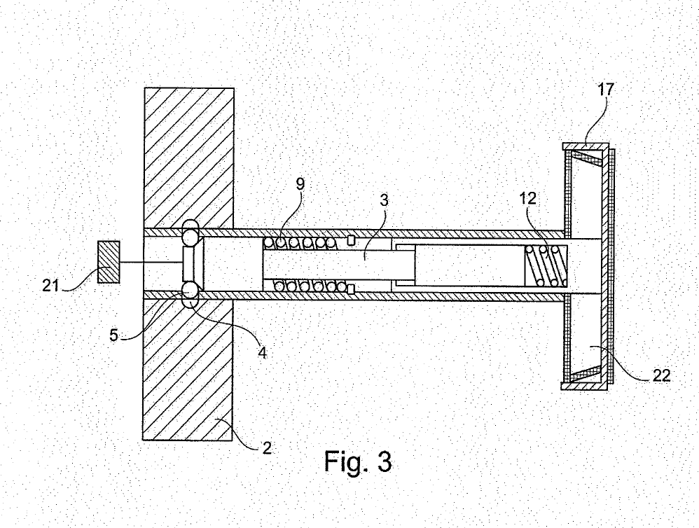

As the force of the actuator continues to act upon draw key 3, the latter is moved farther against the spring force of first spring 12, as shown in FIG. 3. If, due to the shifting movement, the area of draw key 3 having larger diameter D is removed from the contact area of coupling bodies 5, coupling bodies 5 fall back against smaller diameter d of draw key 3, and drive wheel 2 is uncoupled. Bearing shaft 1 and impeller 18 connected thereto thus stop rotating in closed conveying cross-section 22.

If actuator 21 were to fail at the point in time of closed conveying cross-section 22 (FIG. 2), draw key 3 would continue to be pressed back in the direction of drive wheel 2, due to second spring 9, so that guide disk 17 again releases conveying cross-section 22. Drive wheel 2, which is still connected to bearing shaft 1 at this point in time, ensures that coolant continues to be pumped through the system.

Were actuator 21 to fail at the point in time of closed conveying cross-section 22 and an uncoupled drive wheel 2 (FIG. 3), first spring 12 would press draw key 3 in the direction of drive wheel 2, so that coupling bodies 5 slide back into bearing point 4 of drive wheel 2. Second spring 9 would press draw key 3 farther in the direction of drive wheel 2, so that guide disk 17 again releases conveying cross-section 22.

The two springs 9, 12 implement the required failsafe solution, which ensures cooling of the system even if actuator 21 fails.

### LIST OF REFERENCE NUMERALS

1 Bearing shaft
2 Drive wheel
3 Draw key
4 Bearing point
5 Coupling bodies
6 Shifting geometry
7 Axial groove
8 Radial groove
9 Second spring
10 Coupling
11 One-sidedly open cylinder
12 First spring
13 Openings
14 Cylinder base
15 Flat web
16 Draw key end
17 Guide disk
18 Impeller
19 Abutment surface
20 Abutment
21 Actuator
22 Conveying cross-section
23 First shoulder on draw key
24 Second shoulder on draw key
25 Taper

What is claimed is:

1-8. (canceled)

9. A regulatable coolant pump for a cooling circuit of an internal combustion engine, comprising:
a drive wheel;
an impeller;
a hollow bearing shaft carrying the drive wheel on one end and fixedly connected to the impeller on an opposite end, the impeller having an abutment surface on a front side, and a space between the impeller and the abutment surface being designed as a conveying cross-section; and
a draw key, the drive wheel uncouplable from the bearing shaft via the draw key.

10. The regulatable coolant pump as recited in claim 9 further comprising an actuator, the draw key linearly movably situated within the hollow bearing shaft via the actuator.

11. The regulatable coolant pump as recited in claim 9 further comprising a one-sidedly open cylinder on an impeller side linearly movably situated in the hollow bearing shaft, and a first side of the draw key being linearly guided in the cylinder.

12. The regulatable coolant pump as recited in claim 11 further comprising a guide disk situated on a front side of a cylinder base of the one-sidedly open cylinder (11), the guide disk having a projection on an outer edge oriented to partially or completely close the conveying cross-section depending on an axial position of the cylinder.

13. The regulatable coolant pump as recited in claim 9 further comprising a first and second spring axially applying pressure to the draw key.

14. The regulatable coolant pump as recited in claim 9 further comprising a coupling situated in a bearing point of the drive wheel, the draw key, the bearing shaft, the drive wheel and coupling bodies situated between the draw key and the drive wheel defining the coupling.

15. The regulatable coolant pump as recited in claim 14 wherein the bearing point of the drive wheel has a shifting geometry, the shifting geometry having radially and axially running grooves engagable with the coupling bodies.

16. The regulatable coolant pump as recited in claim 14 wherein the coupling bodies are rolling elements.
